(19) United States
(12) Patent Application Publication
(10) Pub. No.: US 2022/0207852 A1
(43) Pub. Date: Jun. 30, 2022

(54) GENERATING A GROUND PLANE FOR OBSTRUCTION DETECTION

(71) Applicant: Blue River Technology Inc., Sunnyvale, CA (US)

(72) Inventors: Divya Sharma, Sunnyvale, CA (US); Ugur Oezdemir, Sunnyvale, CA (US); Lingjian Kong, Sunnyvale, CA (US)

(21) Appl. No.: 17/565,218

(22) Filed: Dec. 29, 2021

Related U.S. Application Data
(60) Provisional application No. 63/131,779, filed on Dec. 29, 2020.

(51) Int. Cl. G06V 10/26; G06V 10/762; G06V 10/25; G06V 10/62; G06V 20/10; G06T 7/70; G05D 1/02

(52) U.S. Cl. CPC G06V 10/26; G06V 10/763; G06V 10/25; G06V 10/62; G06V 20/188; G06V 2201/07; G05D 1/0212; G05D 1/0251; G06T 2207/30188; G06T 2207/30261; G05D 2201/0201; G06T 7/70

(57) ABSTRACT

A control system receives image data of a portion of a field, where the image data comprises a plurality of pixels each representing a three dimensional (3D) coordinate in the field. The control system applies an obstruction identification model to the image data to identify an obstruction in the field. The obstruction identification model determines a seed segment for the field portion and determines a detection ground plane by extrapolating a seed segment to the 3D coordinates of the plurality of pixels. The obstruction identification model identifies a set of pixels of the plurality of pixels that have three dimensional coordinates above the detection ground plane as the obstruction. The control system executes an action for the farming machine to avoid the obstruction in the field based on the obstruction identification model's identification of the obstruction.

### CROSS-REFERENCE To RELATED APPLICATION

This application claims the benefit of U.S. Provisional Application No. 63/131,779, filed Dec. 29, 2020, the contents of which are hereby incorporated in reference in their entirety.

### BACKGROUND

### Field of Disclosure

This disclosure relates to using an obstruction model to identify obstructions in a field, and, more specifically, determining an estimated ground plane for obstruction detection in a field.

### Description of the Related Art

Historically, farming machines that complete farming objectives in a field, such as spraying crops or tilling, use data gathered by sensors on the farming machine to determine instructions for the traversing the filed while completing the farming objectives. For example, as a farming machine moves through a field, the farming machine may encounter objects that may obstruct the farming machine's movement in the field. If the farming machine cannot recognize which objects are obstructions, the farming machine may collide with those obstructions while traversing the field. The collisions, or some other negative interaction with the obstruction, may damage the farming machine and hinder its progress in completing its farming objectives.

A farming machine may employ several models to identify obstructions in the field that the farming machine needs to avoid. However, some objects in the field may be obstructions (given their size), while other objects may not be obstructions. Determining which objects are obstructions with a computer model may be difficult. For example, a boulder is an obstruction that can block the farming machine from moving over the boulder's location in the field. If the boulder is close to the farming machine (e.g., 30 feet in front of the farming machine), a model can easily determine that the boulder is an obstruction that the farming machine should avoid. In contrast, the model has trouble detecting whether boulders that are far away from the farming machine are obstructions. That is, a big boulder and a small rock may appear similar in an image depending on the distance of the objects from the camera. This problem could be alleviated by accounting for a ground plane of the field when identifying obstructions such that a model can determine which objects are obstructions based on their location relative to the farming machine.

### SUMMARY

A farming machine includes one or more cameras for capturing image data as the farming machine moves through a field. The image includes pixels representing the ground, plants, and obstructions. The farming machine includes a control system, and the control system may use image data captured by the one or more cameras to detect obstructions in the field. To detect obstructions, the control system may input the image data to an obstruction identification model that determines a detection ground plane and sets of pixels with three dimensional coordinates above the detection ground plane in the image data, which the control system registers as obstructions.

In particular, the control system receives, from an image acquisition system, image data of a portion of a field. The image acquisition system may be one or more cameras coupled to the farming machine capable of captured image data as a farming machine traverses the field, and the image data may comprise a plurality of pixels where each pixel represents a three dimensional coordinate in the field.

The control system applies an obstruction identification model to the image data to identify an obstruction in the field. The obstruction identification model determines a detection ground plane for the field portion by extrapolating a seed segment to the three dimensional coordinates of the plurality of pixels and identifies a set of pixels of the plurality of pixels that have three dimensional coordinates above the detection ground plane as the obstruction. The control system executes an action for the farming machine to avoid the obstruction in the field based on the obstruction identification model's identification of the obstruction. For instance, the obstruction identification model may indicate a location of the obstruction in the field to the control system, which may modify treatment instructions being carried out by the farming machine to avoid the obstruction as the farming machine traverses the field.

The obstruction identification model may obtain the seed segment in a variety of ways. For instance, the obstruction identification module may extrapolate the seed segment for the portion of the field using a two dimensional representation of the three dimensional coordinates of the plurality of pixels. In another example, the obstruction identification model may determine the seed segment from the image data as the farming machine moves through the field. In this example, the seed segment represents a set of pixels comprising image data representing a plane. Alternatively, the obstruction identification model may access the seed segment from a datastore. This accessed seed segment may have been extrapolated from previously captured image data of one or more other fields and represents a set of pixels comprising image data representing a plane.

### BRIEF DESCRIPTION OF DRAWINGS

FIG. 1A illustrates an isometric view of a farming machine, in accordance with an embodiment.

FIG. 1B illustrates a top view of a farming machine, in accordance with an embodiment.

FIG. 1C illustrates an isometric view of a farming machine, in accordance with an embodiment.

FIG. 2A is a front view of a farming machine, in accordance with an embodiment.

FIG. 2B is an isometric view of an embodiment of a farming machine, in accordance with an embodiment.

FIG. 2C is a side view of a farming machine, in accordance with an embodiment.

FIG. 2D is a top view of a farming machine, in accordance with an embodiment.

FIG. 3 is a block diagram of a system environment of a farming machine, in accordance with an embodiment.

FIG. 4 is a block diagram of an obstruction module, in accordance with an embodiment.

FIG. 5 is a flow chart illustrating a method of detecting obstructions in a field, in accordance with an embodiment.

FIG. 6A depicts a detection ground plane and obstructions in a field, in accordance with an embodiment.

FIG. 6B depicts a detection ground plane and obstructions in a parking lot, in accordance with an embodiment.

FIG. 7 is a block diagram illustrating components of an example machine for reading and executing instructions from a machine-readable medium, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Introduction

A farming machine includes one or more sensors capturing information about a plant as the farming machine moves through a field. The farming machine includes a control system that processes the information obtained by the sensors to identify obstructions in the field and execute an action for the farming machine to avoid the obstruction in the field. In some examples, the control system controls the farming machine to move around the obstruction in the field or alters treatment instructions the farming machine is following to avoid the obstruction in the field. In some examples, the treatment instructions may be for treating a plant, tilling a field, or navigating the field to perform various other farming actions. The control system employs an obstruction identification model to identify obstructions.

Traditionally, image data captured of a field includes objects that a farming machine may encounter as it traverses the field. Such objects may include rocks, workers, farm animals, buildings, and the like. Some objects may be obstructions that block the farming machine from traversing portions of the field. Commonly, these obstructions are large objects, such as rocks, people, and the like, that the farming machine needs to avoid. In contrast, the farming machine may not need to reroute its path through the field to avoid some small objects. For example, a farming machine may easily move over a small rock, tumbleweed, or pile of dirt. However, from a vantage point of the farming machine in the field, it may be difficult to determine from image data captured by the farming machine whether an object is an obstruction or not. For instance, a rock placed 40 feet from the farming machine will look larger in the image data than the same rock placed 100 feet from the farming machine.

Described herein is a farming machine that identifies obstructions in a field using an obstruction identification model. The obstruction identification model determines a detection ground plane of the field, which it uses to identify obstructions in the field outside of the detection ground plane. The obstruction identification model takes, as input, image data captured by the farming machine of the field. The image data may include visual information such as, for example, color information encoded as pixels in an image (e.g., three channels in an RGB image), or some other visual information.

The image sensors of the farming machine are configured to capture images of plants and other objects in a field as the farming machine traverses the field to complete a farming objective. In some embodiments, the farming machine accesses treatment instructions for the farming objective based on the image data and inputs the image data into an obstruction identification model, which is configured to identify obstructions in the field from the image data. The obstruction identification model determines a detection ground plane for a portion of the field shown in the image data by extrapolating a seed segment to three dimensional (3D) coordinates corresponding to the image data. The obstruction identification model may extrapolate the seed segment for portion of the field, determine the seed segment from the image data, or access the seed segment from a datastore. The obstruction identification model identifies sets of pixels from the images data with 3D coordinates above the detection ground plane as obstructions.

If the obstruction identification model identifies an obstruction in image data of the field, the farming machine may move to avoid the obstruction while traversing the field, such as by stopping or turning the farming machine 100. In some embodiments, the farming machine may actuate a treatment mechanism, modify an operating parameter, modify a treatment parameter, and/or modify a sensor parameter when moving to avoid the obstruction. Other modifications are also possible.

### II. Farming Machine

### II.A Example Machine Configurations

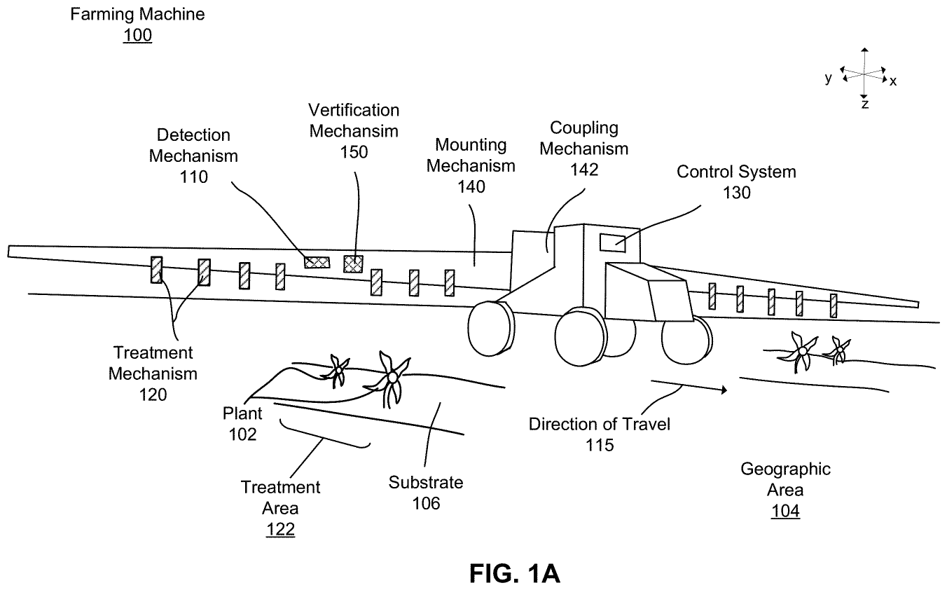

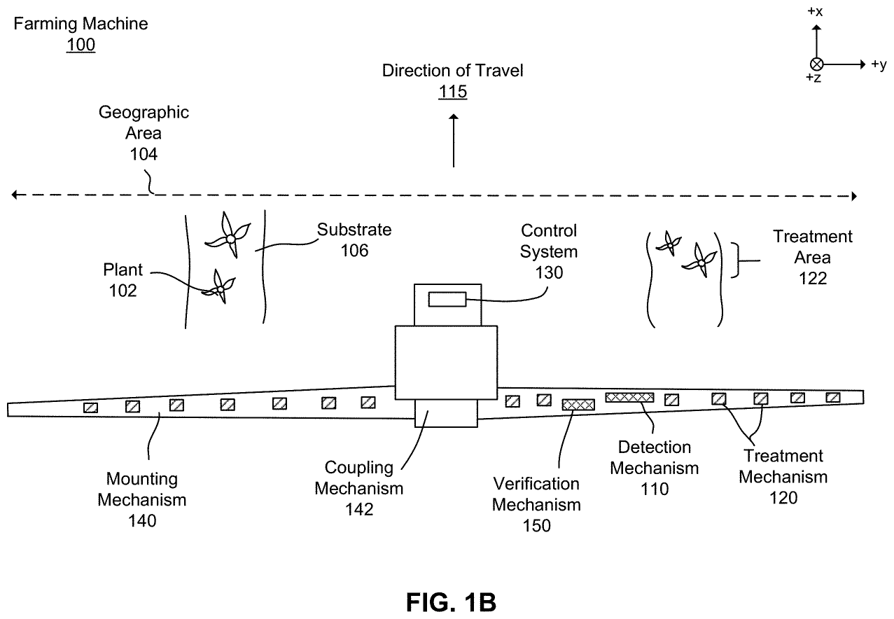

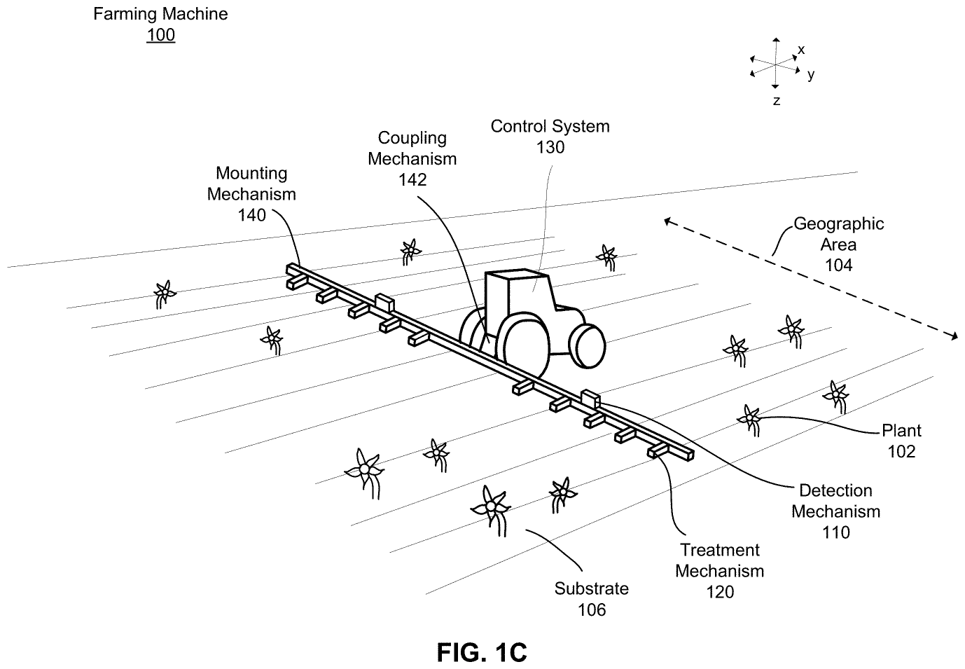

A farming machine that identifies and treats plants may have a variety of configurations, some of which are described in greater detail below. For example, FIG. 1A is an isometric view of a farming machine and FIG. 1B is a top view of the farming machine of FIG. 1A. FIG. 1C is a second embodiment of a farming machine. Other embodiments of a farming machine are also possible. The farming machine 100, illustrated in FIGS. 1A-1C, includes a detection mechanism 110, a treatment mechanism 120, and a control system 130. The farming machine 100 can additionally include a mounting mechanism 140, a verification mechanism 150, a power source, digital memory, communication apparatus, or any other suitable component. The farming machine 100 can include additional or fewer components than described herein. Furthermore, the components of the farming machine 100 can have different or additional functions than described below.

The farming machine 100 functions to apply a treatment to one or more plants 102 within a geographic area 104. Often, treatments function to regulate plant growth. The treatment is directly applied to a single plant 102 (e.g., hygroscopic material), but can alternatively be directly applied to multiple plants, indirectly applied to one or more plants, applied to the environment associated with the plant (e.g., soil, atmosphere, or other suitable portion of the plant environment adjacent to or connected by an environmental factor, such as wind), or otherwise applied to the plants. Treatments that can be applied include necrosing the plant, necrosing a portion of the plant (e.g., pruning), regulating plant growth, or any other suitable plant treatment. Necrosing the plant can include dislodging the plant from the supporting substrate 106, incinerating a portion of the plant, applying a treatment concentration of working fluid (e.g., fertilizer, hormone, water, etc.) to the plant, or treating the plant in any other suitable manner. Regulating plant growth can include promoting plant growth, promoting growth of a plant portion, hindering (e.g., retarding) plant or plant portion growth, or otherwise controlling plant growth. Examples of regulating plant growth includes applying growth hormone to the plant, applying fertilizer to the plant or substrate, applying a disease treatment or insect treatment to the plant, electrically stimulating the plant, watering the plant, pruning the plant, or otherwise treating the plant. Plant growth can additionally be regulated by pruning, necrosing, or otherwise treating the plants adjacent to the plant.

The plants 102 can be crops but can alternatively be weeds or any other suitable plant. The crop may be cotton, but can alternatively be lettuce, soybeans, rice, carrots, tomatoes, corn, broccoli, cabbage, potatoes, wheat or any other suitable commercial crop. The plant field in which the system is used is an outdoor plant field, but can alternatively be plants within a greenhouse, a laboratory, a grow house, a set of containers, a machine, or any other suitable environment. The plants are grown in one or more plant rows (e.g., plant beds), wherein the plant rows are parallel, but can alternatively be grown in a set of plant pots, wherein the plant pots can be ordered into rows or matrices or be randomly distributed, or be grown in any other suitable configuration. The crop rows are generally spaced between 2 inches and 45 inches apart (e.g. as determined from the longitudinal row axis), but can alternatively be spaced any suitable distance apart, or have variable spacing between multiple rows.

The plants 102 within each plant field, plant row, or plant field subdivision generally includes the same type of crop (e.g., same genus, same species, etc.), but can alternatively include multiple crops (e.g., a first and a second crop), both of which are to be treated. Each plant 102 can include a stem, arranged superior (e.g., above) the substrate 106, which supports the branches, leaves, and fruits of the plant. Each plant can additionally include a root system joined to the stem, located inferior to the substrate plane (e.g., below ground), that supports the plant position and absorbs nutrients and water from the substrate 106. The plant can be a vascular plant, non-vascular plant, ligneous plant, herbaceous plant, or be any suitable type of plant. The plant can have a single stem, multiple stems, or any number of stems. The plant can have a tap root system or a fibrous root system. The substrate 106 is soil but can alternatively be a sponge or any other suitable substrate.

The detection mechanism 110 is configured to identify a plant for treatment. As such, the detection mechanism 110 can include one or more sensors for identifying a plant. For example, the detection mechanism 110 can include a multispectral camera, a stereo camera, a CCD camera, a single lens camera, a CMOS camera, hyperspectral imaging system, LIDAR system (light detection and ranging system), a depth sensing system, dynamometer, IR camera, thermal camera, humidity sensor, light sensor, temperature sensor, or any other suitable sensor. In one embodiment, and described in greater detail below, the detection mechanism 110 includes an array of image sensors configured to capture an image of a plant. In some example systems, the detection mechanism 110 is mounted to the mounting mechanism 140, such that the detection mechanism 110 traverses over a geographic location before the treatment mechanism 120 as the farming machine 100 moves through the geographic location. However, in some embodiments, the detection mechanism 110 traverses over a geographic location at substantially the same time as the treatment mechanism 120. In an embodiment of the farming machine 100, the detection mechanism 110 is statically mounted to the mounting mechanism 140 proximal the treatment mechanism 120 relative to the direction of travel 115. In other systems, the detection mechanism 110 can be incorporated into any other component of the farming machine 100.

The treatment mechanism 120 functions to apply a treatment to an identified plant 102. The treatment mechanism 120 applies the treatment to the treatment area 122 as the farming machine 100 moves in a direction of travel 115. The effect of the treatment can include plant necrosis, plant growth stimulation, plant portion necrosis or removal, plant portion growth stimulation, or any other suitable treatment effect as described above. The treatment can include plant 102 dislodgement from the substrate 106, severing the plant (e.g., cutting), plant incineration, electrical stimulation of the plant, fertilizer or growth hormone application to the plant, watering the plant, light or other radiation application to the plant, injecting one or more working fluids into the substrate 106 adjacent the plant (e.g., within a threshold distance from the plant), or otherwise treating the plant. In one embodiment, the treatment mechanisms 120 are an array of spray treatment mechanisms. The treatment mechanisms 120 may be configured to spray one or more of: an herbicide, a fungicide, water, or a pesticide. The treatment mechanism 120 is operable between a standby mode, wherein the treatment mechanism 120 does not apply a treatment, and a treatment mode, wherein the treatment mechanism 120 is controlled by the control system 130 to apply the treatment. However, the treatment mechanism 120 can be operable in any other suitable number of operation modes.

The farming machine 100 may include one or more treatment mechanisms 120. A treatment mechanism 120 may be fixed (e.g., statically coupled) to the mounting mechanism 140 or attached to the farming machine 100 relative to the detection mechanism 110. Alternatively, the treatment mechanism 120 can rotate or translate relative to the detection mechanism 110 and/or mounting mechanism 140. In one variation, the farming machine 100 includes a single treatment mechanism, wherein the treatment mechanism 120 is actuated or the farming machine 100 moved to align the treatment mechanism 120 active area 122 with the targeted plant 102. In a second variation, the farming machine 100 includes an assembly of treatment mechanisms, wherein a treatment mechanism 120 (or subcomponent of the treatment mechanism 120) of the assembly is selected to apply the treatment to the identified plant 102 or portion of a plant in response to identification of the plant and the plant position relative to the assembly. In a third variation, such as shown in FIGS. 1A-1C, the farming machine 100 includes an array of treatment mechanisms 120, wherein the treatment mechanisms 120 are actuated or the farming machine 100 is moved to align the treatment mechanism 120 active areas 122 with the targeted plant 102 or plant segment.

The farming machine 100 includes a control system 130 for controlling operations of system components. The control system 130 can receive information from and/or provide input to the detection mechanism 110, the verification mechanism 150, and the treatment mechanism 120. The control system 130 can be automated or can be operated by a user. In some embodiments, the control system 130 may be configured to control operating parameters of the farming machine 100 (e.g., speed, direction). The control system 130 also controls operating parameters of the detection mechanism 110. Operating parameters of the detection mechanism 110 may include processing time, location and/or angle of the detection mechanism 110, image capture intervals, image capture settings, etc. The control system 130 may be a computer, as described in greater detail below in relation to FIG. 11. The control system 130 can apply one or more models to determine a detection ground plane of the field and identify one or more obstructions in the field. In some embodiments, the control system applies an obstruction identification model to identify obstructions, which is described in greater detail below. The control system 130 may be coupled to the farming machine 100 such that a user (e.g., a driver) can interact with the control system 130. In other embodiments, the control system 130 is physically removed from the farming machine 100 and communicates with system components (e.g., detection mechanism 110, treatment mechanism 120, etc.) wirelessly. In some embodiments, the control system 130 is an umbrella term that includes multiple networked systems distributed across different locations (e.g., a system on the farming machine 100 and a system at a remote location). In some embodiments, one or more processes are performed by another control system. For example, the control system 130 receives plant treatment instructions from another control system.

In some configurations, the farming machine 100 includes a mounting mechanism 140 that functions to provide a mounting point for the system components. In one example, the mounting mechanism 140 statically retains and mechanically supports the positions of the detection mechanism 110, the treatment mechanism 120, and the verification mechanism 150 relative to a longitudinal axis of the mounting mechanism 140. The mounting mechanism 140 is a chassis or frame but can alternatively be any other suitable mounting mechanism. In the embodiment of FIGS. 1A-1C, the mounting mechanism 140 extends outward from a body of the farming machine 100 in the positive and negative y-direction (in the illustrated orientation of FIGS. 1A-1C) such that the mounting mechanism 140 is approximately perpendicular to the direction of travel 115. The mounting mechanism 140 in FIGS. 1A-1C includes an array of treatment mechanisms 120 positioned laterally along the mounting mechanism 140. In alternate configurations, there may be no mounting mechanism 140, the mounting mechanism 140 may be alternatively positioned, or the mounting mechanism 140 may be incorporated into any other component of the farming machine 100.

The farming machine 100 includes a first set of coaxial wheels and a second set of coaxial wheels, wherein the rotational axis of the second set of wheels is parallel with the rotational axis of the first set of wheels. In some embodiments, each wheel in each set is arranged along an opposing side of the mounting mechanism 140 such that the rotational axes of the wheels are approximately perpendicular to the mounting mechanism 140. In FIGS. 1A-1C, the rotational axes of the wheels are approximately parallel to the mounting mechanism 140. In alternative embodiments, the system can include any suitable number of wheels in any suitable configuration. The farming machine 100 may also include a coupling mechanism 142, such as a hitch, that functions to removably or statically couple to a drive mechanism, such as a tractor, more to the rear of the drive mechanism (such that the farming machine 100 is dragged behind the drive mechanism), but can alternatively be attached to the front of the drive mechanism or to the side of the drive mechanism. Alternatively, the farming machine 100 can include the drive mechanism (e.g., a motor and drive train coupled to the first and/or second set of wheels). In other example systems, the system may have any other means of traversing through the field.

In some configurations, the farming machine 100 additionally includes a verification mechanism 150 that functions to record a measurement of the ambient environment of the farming machine 100. The farming machine may use the measurement to verify or determine the extent of plant treatment. The verification mechanism 150 records a measurement of the geographic area previously measured by the detection mechanism 110. The verification mechanism 150 records a measurement of the geographic region encompassing the plant treated by the treatment mechanism 120. The verification mechanism 150 measurement can additionally be used to empirically determine (e.g., calibrate) treatment mechanism operation parameters to obtain the desired treatment effect. The verification mechanism 150 can be substantially similar (e.g., be the same type of mechanism as) to the detection mechanism 110 or can be different from the detection mechanism 110. In some embodiments, the verification mechanism 150 is arranged distal the detection mechanism 110 relative the direction of travel, with the treatment mechanism 120 arranged there between, such that the verification mechanism 150 traverses over the geographic location after treatment mechanism 120 traversal. However, the mounting mechanism 140 can retain the relative positions of the system components in any other suitable configuration. In other configurations of the farming machine 100, the verification mechanism 150 can be included in other components of the system.

In some configurations, the farming machine 100 may additionally include a power source, which functions to power the system components, including the detection mechanism 110, control system 130, and treatment mechanism 120. The power source can be mounted to the mounting mechanism 140, can be removably coupled to the mounting mechanism 140, or can be separate from the system (e.g., located on the drive mechanism). The power source can be a rechargeable power source (e.g., a set of rechargeable batteries), an energy harvesting power source (e.g., a solar system), a fuel consuming power source (e.g., a set of fuel cells or an internal combustion system), or any other suitable power source. In other configurations, the power source can be incorporated into any other component of the farming machine 100.

In some configurations, the farming machine 100 may additionally include a communication apparatus, which functions to communicate (e.g., send and/or receive) data between the control system 130 and a set of remote devices. The communication apparatus can be a Wi-Fi communication system, a cellular communication system, a short-range communication system (e.g., Bluetooth, NFC, etc.), or any other suitable communication system.

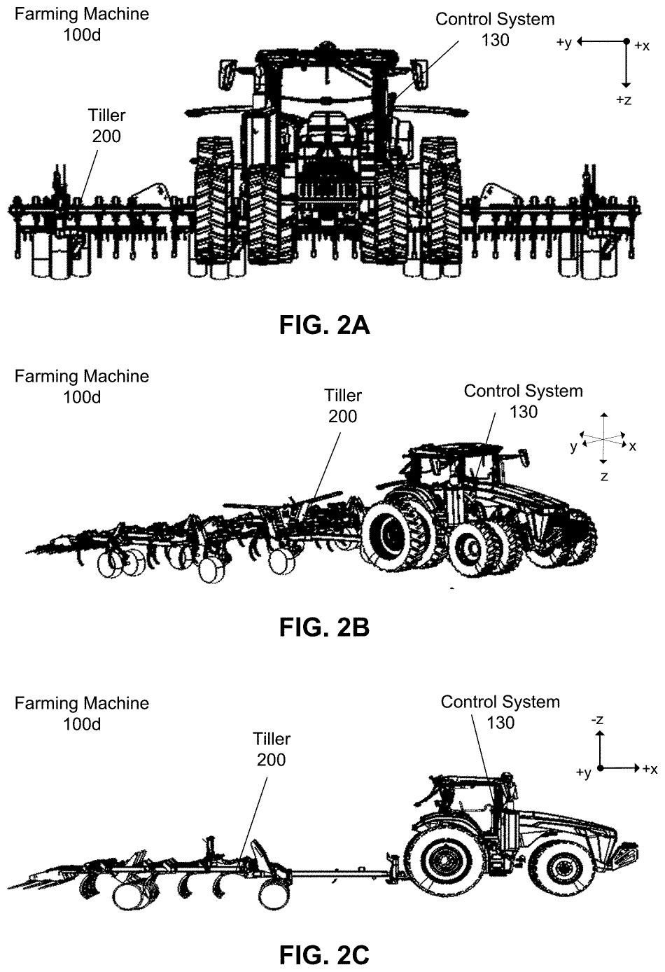

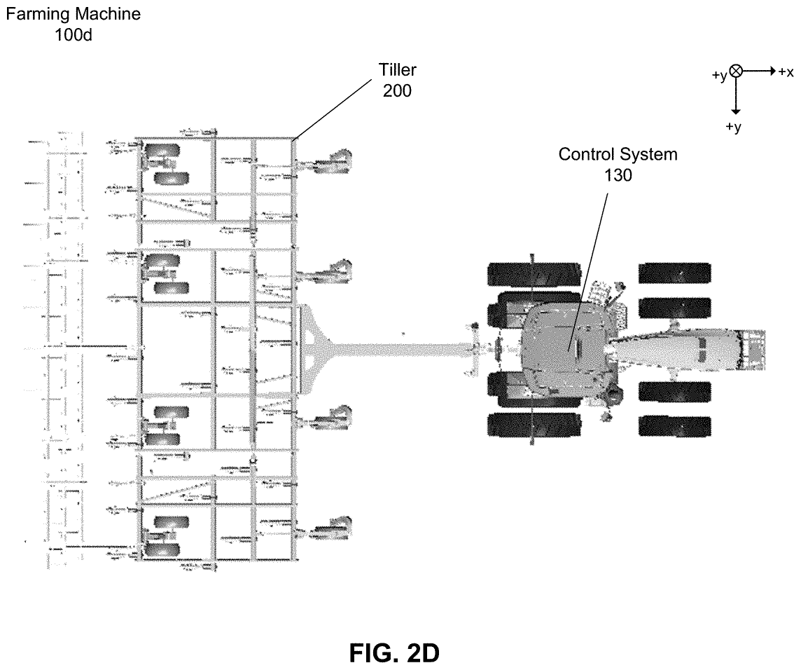

FIGS. 2A-D depict a farming machine 100d with a tiller, in accordance with an embodiment. For example, FIG. 2A is a front view of the embodiment of the farming machine 100d and FIG. 2B is an isometric view of the embodiment of the farming machine 100d of FIG. 2A. FIG. 2C is a side view of the embodiment of the farming machine 100d and FIG. 2D is a top view of the embodiment of the farming machine 100d.

The farming machine 100d may use field action mechanisms coupled to a tiller 200 of the farming machine to complete the field actions. The field actions may include tilling, spraying, or otherwise treating a plant, as previously described in relation to FIGS. 1A-C. Further, the farming machine includes a control system 130 for controlling operations of system components of the farming machine 100d to take field actions and may include any of the other components, mechanisms, networks, and sensors previously described in relation to FIGS. 1A-1C.

### II.B System Environment

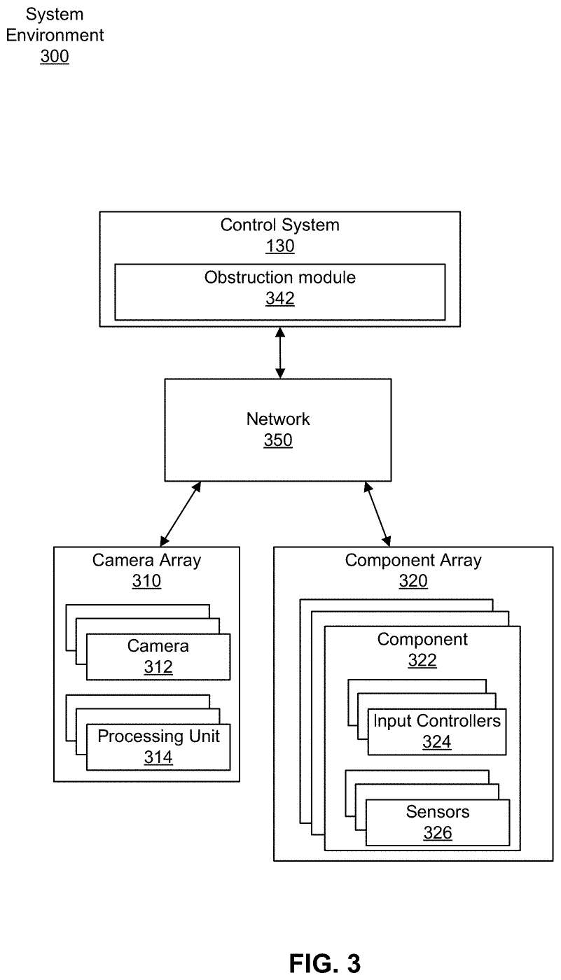

FIG. 3 is a block diagram of the system environment 300 for the farming machine 100, in accordance with an embodiment. In this example, the control system 310 is connected to a camera array 320 and component array 130 via a network 350 within the system environment 300.

The camera array 320 includes one or more cameras 322. The cameras 322 may be a detection mechanism 110 as described in FIG. 1. Each camera 322 in the camera array 320 may be controlled by a corresponding processing unit 324 (e.g., a graphics processing unit). In some examples, more than one camera 332 may be controlled by a single processing unit 334. The array 320 captures image data of the scene around the farming machine 100. The captured image data may be sent to the control system 130 via the network 310 or may be stored or processed by other components of the farming machine 100.

The component array 320 includes one or more components 322. Components 322 are elements of the farming machine that can take farming actions (e.g., a treatment mechanism 120). As illustrated, each component has one or more input controllers 324 and one or more sensors, but a component may include only sensors or only input controllers. An input controller controls the function of the component. For example, an input controller may receive machine commands via the network and actuate the component in response. A sensor 326 generates measurements within the system environment. The measurements may be of the component, the farming machine, or the environment surrounding the farming machine. For example, a sensor 326 may measure a configuration or state of the component 322 (e.g., a setting, parameter, power load, etc.), or measure an area surrounding a farming machine (e.g., moisture, temperature, etc.).

The control system 130 receives information from the camera array 310 and component array 320 and generates farming actions. In particular, the control system 130 employs a plant identification module 332 to identify plants in the scene and generate corresponding treatment actions. Further, the information from the camera array 310 may be image data describing a portion of a field (henceforth referred to as a “field portion”) based on the farming machine's 100 location within the field. For example, the image data may correspond to location determined from a Global Position System (GPS) of the farming machine 100. Therefore, the image data comprises pixels, and each pixel may be associated with 3D coordinates representing a location in the field portion.

The plant identification module 332 includes a depth identification model 334, an image labeling model 336, a map labeling model 338, and a point cloud generation model 340. As described herein, the depth identification model 334 identifies depth information from visual information obtained by the camera array 310, the image labelling model 336 labels visual information in visual information obtained by the camera array, the map labeling model 338 label depth maps, and the point cloud generation model 340 generates a labelled point cloud based on the depth information and labelled images.

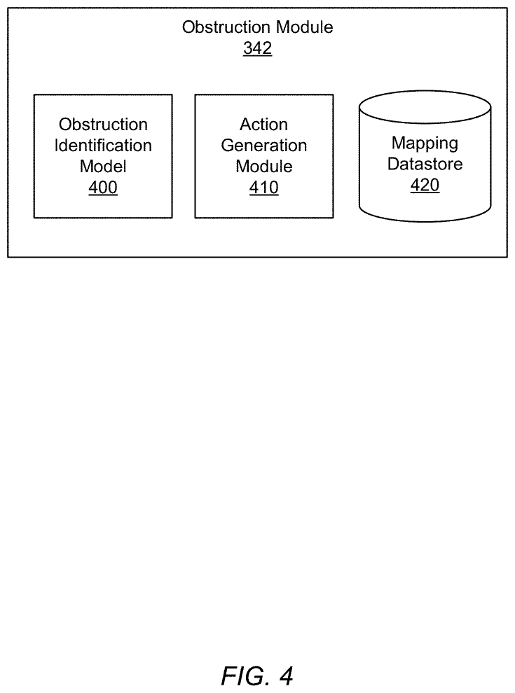

The control system 130 includes an obstruction module 342, which acts to identify obstructions from image data captured by a farming machine 100 in a field. The control system 130 inputs image data from the camera array 310 to the obstruction module 342 to determine a detection ground plane of the field portion. The detection ground plane is used to identify obstructions in the field portion and determine actions for the farming machine 100 to execute to avoid the obstructions. The obstruction module is further described in relation to FIG. 4.

The network 350 connects nodes of the system environment 300 to allow microcontrollers and devices to communicate with each other. In some embodiments, the components are connected within the network as a Controller Access Network (CAN). In this case, within the CAN each element has an input and output connection, and the CAN 310 can translate information between the various elements. For example, the CAN receives input information from the camera array 310 and component array 320, processes the information, and transmits the information to the control system 130. The control system 130 generates a farming action based on the information and transmits instructions to implement the farming action to the appropriate component(s) 322 of the component array 320.

Additionally, the system environment 300 may be other types network environments and include other networks, or a combination of network environments with several networks. For example, the system environment 300, can be a network such as the Internet, a LAN, a MAN, a WAN, a mobile wired or wireless network, a private network, a virtual private network, a direct communication line, and the like.

### III Identifying Obstructions

As described above, the control system 130 employs an obstruction module 342 to identify obstructions. FIG. 4 is a block diagram of the obstruction module 342, in accordance with an embodiment. In this example, the obstruction module 342 includes an obstruction identification model 400, an action generation module 410, and a mapping datastore 420. In other embodiments, the obstruction module 342 may include more or less modules that are applied in conjunction with one another to detect obstructions and determine actions for the farming machine 100 to avoid the obstructions in the field.

The obstruction identification model 400 detects obstructions in a field. The obstruction identification module 400 receives image data in real-time from the camera array 310 as the farming machine 100 traverses a field. The image data comprises information that represents a 3D description of a field portion, as captured by the camera array 310 on the farming machine 100.

The image data comprises a plurality of pixels (e.g., red, green, and blue pixels, or “RGB” pixels), which are processed by the obstruction identification model 400 to create a 3D representation of the field portion. In particular, the obstruction identification model 400 associates each RGB pixel of the image data to GPS data describing the location of the farming machine 100 when the image data was taken and determines 3D coordinates for each RGB pixel based on the GPS data. This can be done with image data from a mono camera or multiple stereo cameras in the camera array 310. This is described in related U.S. application Ser. No. 17/033,263, filed on Sep. 25, 2020, which is incorporated herein by reference in its entirety for all purposes.

In some embodiments, the obstruction identification model 400 retrieves the image data that already describes a 3D representation of the field portion from a datastore of image data. In these embodiments, the image data may have been previously captured in the field.

### III.A Identifying a Ground Plane

The obstruction identification model 400 can determine a detection ground plane of the field portion. A detection ground plane is a plane in the field portion representing the ground and may be used to identify obstructions in the field portion. The obstruction identification model 400 may determine the detection ground plane in multiple ways.

In a first example, the obstruction identification model 400 applies random sample consensus (RANSAC) to the 3D representation of the field portion to obtain the detection ground plane. When using RANSAC, the detection ground plane may be noisy (e.g., include small plants and other errors). To reduce the noise in the detection ground plane, the obstruction identification model 400 may convert the detection ground plane from its representation in the 3D point cloud to 2D representation. Once the detection ground plane is represented in 2D, the obstruction identification model 400 fill in gaps in the converted detection ground plane. For example, the conversion may have caused the noisy areas to go unrepresented (or misrepresented) in the 2D representation, and the obstruction identification module 400 can extrapolate the detection ground plane to those areas. Afterwards, the obstruction identification module converts the filled-in detection ground plane back to 3D. This 3D to 2D to 3D process reduces noise in the detection ground plane.

In a second example, the obstruction identification model 400 uses real-time pixel identification of ground pixels to determine the detection ground plane. The obstruction identification model 400 may identify ground pixels by color or by estimated distance of the pixels to the camera array 310. For example, the obstruction identification model 400 may identify plane-indicating pixels, which are pixels representing a part of the filed typically classified as ground (i.e., grass or dirt), and classify those pixels as part of the detection ground plane. As an example, the obstruction identification module can employ a model similar to that disclosed in U.S. application Ser. No. 16/126,842, filed on Sep. 10, 2018, which is incorporated herein by reference in its entirety for all purposes.

In a third example, the obstruction identification model 400 may use previously determined ground plane information for the field portion or the field to determine the detection ground plane. For example, the obstruction identification model 400 may use a previously determined ground plane retrieved from a datastore and apply that ground plane to the current image. Similarly, the obstruction identification model may determine the detection ground plane using pixel detection on previously captured image data of the field portion or field and apply that ground plane to the current image.

Determining and processing the detection ground plane through one of these three methods can be computationally expensive because it is applied to an entire image. Therefore, rather than determining the detection ground plane at a macro level as described, the obstruction identification model 400 may also use a seed segment to determine a detection ground plane. The seed segment is a portion of the image data showing the ground of the field and comprises a plurality of pixels representing the ground. The obstruction identification model 400 uses to determined seed segment to determine the detection ground plane of the field.

Alternatively stated, the seed segment is a group of pixels (in received or accessed image data) whose characteristics can be extrapolated to the remaining pixels of the image data. Indeed, because pixels of the seed segment represent the ground, planar characteristics of the pixels in that seed segment can be extrapolated to other pixels in the image data representing the ground. More simply, because the ground in the seed segment, presumably, shares the same plane as the ground in the rest of the image, the planar characteristics of the ground in the seed segment can be extrapolated to the ground in the remainder of the image data.

The obstruction identification model 400 may obtain the seed segment using any of the methods previously described to determine the detection ground plane. That is, the obstruction identification model 400 employs the previous methods to determine a small segment of a ground plane in an image, rather than the entire ground plane in an image. For instance, the obstruction identification model 400 may obtain the seed segment by applying RANSAC to a portion of the 3D representation of the field portion, using real-time identification of ground pixels on a portion of the image data, or using a portion of a previously determined detection ground plane. In another example, the obstruction identification model 400 may receive, from a client device connected to the control system 130 via the network, a user selection of a set of pixels in the image data representing the ground plane. In a further example related to the second example above, the obstruction identification model 400 may determine the seed segment from image data as the farming machine 100 moves through the field. In this example, the set of pixels of the seed segment may comprise received image data representing a plane. In yet another example related to the third example above, the obstruction identification model 400 may access the seed segment from a datastore, where the accessed seed segment is extrapolated from previously captured image data of one or more fields and comprises a previously captured set of pixels comprising image data representing a plane.

The obstruction identification model 400 uses the seed segment to determine a detection ground plane of the field portion by extrapolating the seed segment to an entire detection ground plane. For instance, the obstruction identification model 400 expands the seed segment to include nearby pixels of similar color, pixels within a same shape, pixels within a cluster, or some other extrapolation method. In another example, using RANSAC as described above, the obstruction identification model 400 extrapolates characteristics of the seed segment to the field portion using a two dimensional representation of the three dimensional coordinates for the pixels. The obstruction identification model 400 expands the seed segment into the detection ground plane until there are no more pixels directly next to pixels in the extrapolated seed segment in the frequency range of the color and within the threshold height. The obstruction identification model 400 may store the detection ground plane in a datastore for future use in the field.

In an example, the obstruction identification model 400 identifies a seed segment that is a small patch of brown pixels. The obstruction identification model 400 expands the seed segment to nearest neighbor pixels (or next-nearest neighbor pixels, etc.) that are within a frequency range of the colors in the seed segment. For example, the obstruction identification model 400 expands the seed segment to include surrounding pixels with lighter and dark brown pixels, but does not include blue pixels. The obstruction identification model 400 then stores the detection ground plane in a datastore.

In some configurations, the obstruction identification model 400 includes pixels from the image data below a threshold height when extrapolating the seed segment to the detection ground plane. That is, pixels having a height above the threshold height are not included in the detection ground plane. This is the case because any pixels below the threshold height are assumed to not be an obstruction for the farming machine as it moves through the field. For instance, the ground in the image may include inflections and undulations below the threshold height. Similarly, the pixels may represent small objects, such as weeds, bushes, or rocks that are also below the threshold height. By extrapolating the detection ground plane to include pixels up to the threshold height, the obstruction identification model 400 reduces its chance of detecting small objects as obstructions and prevents the farming machine 100 from unnecessarily stopping or rerouting to avoid small objects in the field.

### III.B Obstructions Relative the Ground Plane

Once the obstruction identification module 400 has determined the detection ground plane, the obstruction identification module 400 identifies obstruction pixels. Here, obstructions pixels are sets of pixels with 3D coordinates outside (i.e., above or below) of the detection ground plane in the image data. The obstruction pixels represent objects in the image that are obstructions for the farming machine 100. Obstruction pixels may be above or below the detection ground plane (e.g., a boulder or a deep trench).

To identify obstructions, the obstruction identification model 400 bins obstruction pixels having approximately the same x- and y-coordinates into groups. Each group has corresponding z-coordinates which are outside of the detection ground plane. In an example, the obstruction identification model 400 may employs k-means clustering to identify and group obstruction pixels having similar x- and y-coordinates with z-coordinates above or below the ground plane.

The obstruction identification model 400 creates a representation of each group of obstruction pixels. In a configuration, the representation is a tube that projects out from the detection ground plane in the z-direction, but could be some other representation of the obstruction. In some embodiments, the obstruction identification model 400 only makes tubes that are sufficiently tall to be identified as an obstruction (i.e., reach a threshold height above the detection ground plane). The obstruction identification model 400 then flags each tube as an obstruction in the field portion because they are above a threshold height and may impede the farming machine. Each flagged tube is associated with a specific set of coordinates and height. The obstruction identification model 400 sends the flagged tubes (i.e., obstructions) to the action generation module 410.

The obstruction identification model 400 may update the detection ground plane and identify more obstructions as the farming machine 100 moves through the field. In particular, as the farming machine moves in the field, the image data may show more (or different) parts of the field than the original field portion. In this case, the obstruction identification model 400 may extrapolate the ground plane to the new parts of the field, or extrapolate a new ground plane, and detect other obstructions in the new or different parts. The obstruction identification model 400 may also reevaluate the ground plane and obstructions on a continual, or semi continual basis. This is useful because, in some cases, the image data may show an object far away from the farming machine 100 as a small object, whereas, in reality, the object is large and would obstruct the farming machine.

The obstruction identification model 400 may further label binned pixels as static or dynamic obstacles. For instance, the obstruction identification model 400 may input binned pixels corresponding to obstructions into a machine learning model which classifies the pixels as corresponding to static obstructions (i.e., obstructions that do not move such as rocks, plants, buildings, etc.) or dynamic obstructions (i.e., obstructions that do move such as people, cows, dogs, vehicles, etc.). The machine learning model may be trained on labelled image data of static and dynamic obstructions. In another example, the obstruction identification model 400 may receive multiple set of image data captured at periodic time intervals as the farming machine 100 traverses the field. The obstruction identification model 400 bins pixels in each set of image data and compares locations of binned pixels in each set of image data to determine if obstructions corresponding to the binned pixels are static or dynamic.

In some embodiments, the obstruction identification model 400 additionally uses a combination of a deep neural network (DNN) and fusion on the image data to flag further obstructions in the field portion. The DNN may label each obstruction (e.g., “cow,” “rock,” “hay,” etc.) and, based on the labels, classify the obstructions as static or dynamic. For example, an obstruction labeled as a “cow” would be dynamic, while an obstruction labelled as “corn stalk” would be static. The DNN may include multiple layers between an input layer and an output layer that define a mathematical relationship between the input and output. The obstruction identification model 400 may send the obstructions determined by the DNN with fusion to the action generation module 410.

Rather than flagging obstructions in the image data, in some embodiments, the obstruction identification model 400 labels pixels in the detection ground plane as “drivable” or “not drivable” for the farming machine 100. In particular, the obstruction identification model 400 determines x- and y-coordinates of obstructions and labels areas of the detection ground plane with corresponding x- and y-coordinates as “not drivable.” The obstruction identification model 400 may label the remaining pixels of the detection ground plane as “drivable.”

The action generation module 410 determines actions for the farming machine 100 to avoid obstructions in the field. For example, the action generation module 410 receives obstructions and determines if those obstructions interfere with a planned path of the machine. To do so, the action generation module 410 retrieves a planned path of the farming machine 100 in the field from the map datastore 420. A planned path is a previously mapped out route through the field for the farming machine 100 to take to complete a farming objective. Planned paths are stored in the mapping datastore 420 along with instructions for the farming machine to take to complete a farming objective. Planned paths may be split into segments, such that the planned path may be updated by altering individual segments of the path to route the farming machine around obstructions.

Returning to the example, the action generation module 410 determines whether any of the obstructions correspond to the planned path. If so, the action generation module 410 may generate or modify the instructions for the farming machine to take in the field. In particular, the action generation module 410 may cause the farming machine 100 to stop, slow down, sound an alarm, or otherwise take action to avoid the obstructions in the field. For instance, the planned path for the farming machine 100 may be determined using passive mapping, where the planned path is created in segments for the field, so the action generation module 410 may replan a segment of the planned path obstructed by a flagged obstruction. The action generation module 410 may replan the segment to avoid the obstruction while still allowing the farming machine 100 to complete one or more farming objectives, such as spraying or tilling the field, and replace the segment with the replanned segment in the planned path.

### III.C Process for Obstruction Identification

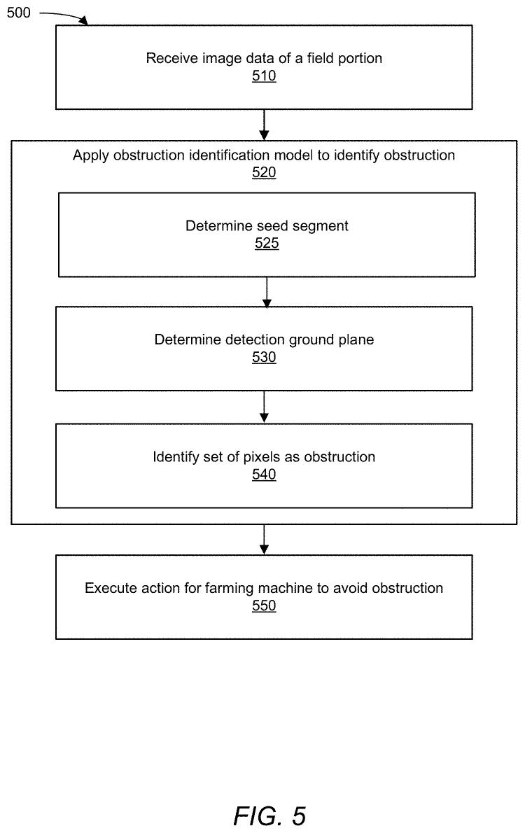

FIG. 5 is a flow chart illustrating a method 500 of detecting obstructions in a field, in accordance with an embodiment. The obstruction module 342 receives 510 image data of a field portion from the camera system 100. In some embodiments, the obstruction module 342 receives the image data in real-time via the network 310 as the farming machine 100 traverses the field. The image data comprises a plurality of pixels each representing a 3D coordinate in the field.

The obstruction module 342 applies 520 the obstruction identification model 400 to identify obstructions in the field portion. In particular, the obstruction identification model 400 determines 525 a seed segment for the field portion, where the seed segment comprises a set of pixels with characteristics extrapolatable to the field portion. The obstruction identification model 400 determines 530 a detection ground plane of the field portion by extrapolating characteristics of the seed segment to the 3D coordinates of the plurality of pixels of the image data. The obstruction identification model 400 may extrapolate the detection ground plane up to a threshold height to include small objects that are close to the ground in the detection ground plane, such that the small objects will not be detected as obstructions. The seed segment is a plurality of pixels that represent the plane of the ground, and the obstruction identification model 400 may access the seed segment in a datastore, where the seed segment was previously extrapolated from previous image data, extrapolate the seed segment using a 2D representation of coordinates for the plurality of pixels in the image data, or determine the seed segment from the image data. Further, the obstruction identification model 400 may receive a user input indicating which pixels in the image data represent the ground.

The obstruction identification model 400 identifies 540 sets of pixels as obstructions in the image data. For instance, the obstruction identification module may remove the detection ground plane from the image data or may only review pixels of the image data outside of the 3D coordinates of the detection ground plane. The obstruction identification model 400 segments the image data into buckets by distance to the farming machine 100 and bins pixels of the remaining image data having 3D coordinates above a threshold height (e.g., the detection ground plane) into 1D tubes in the buckets. The obstruction identification model identifies buckets comprising binned pixels as obstructions. Alternatively or additionally, the obstruction identification model 400 may apply k-means clustering to the pixels and add clusters to the buckets. The obstruction identification model 400 identifies buckets with binned pixels as obstructions.

The obstruction module 342 receives the identified obstructions, which may include coordinate of the obstructions, and executes 550 actions for the farming machine 100 to take to avoid the obstructions. For example, the obstruction module 342 may cause the farming machine 100 to stop, slow down, or sound an alarm. Furthermore, the obstruction module 342 may retrieve a planned path of the farming machine 100 in the field and replan the path to avoid the obstructions.

### IV. Ground Plane Detection Examples

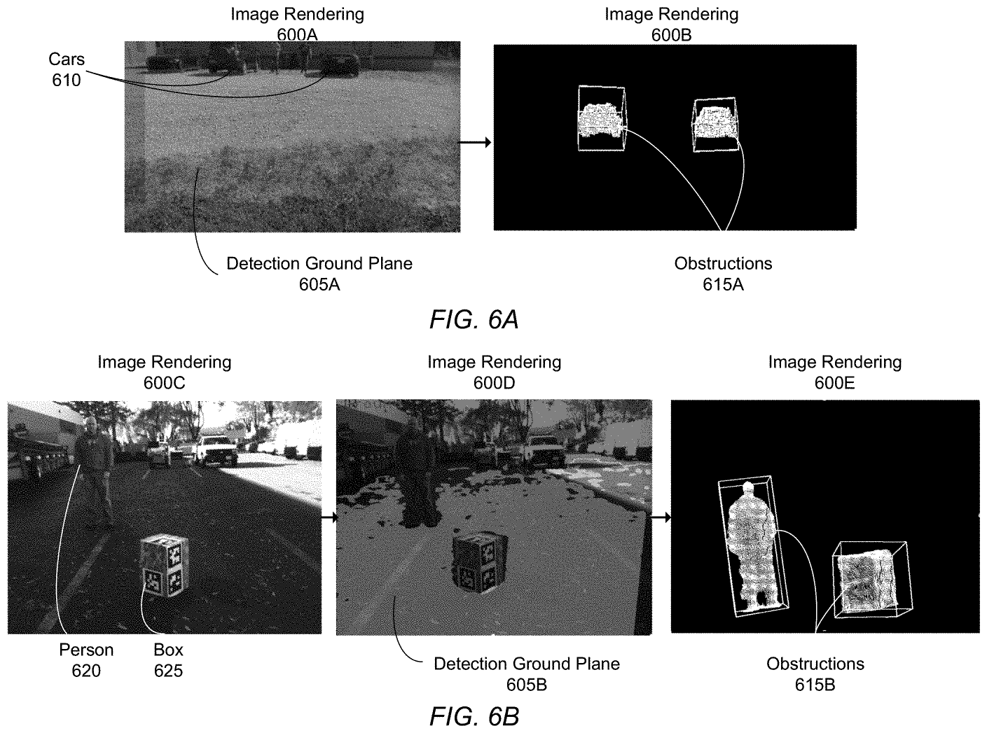

FIGS. 6A and 6B illustrate examples of detection ground planes 605 and detected obstructions 615. FIG. 6A shows an image rendering 600A rendered from image data of a field with two cars 610A in the background of the image rendering 600A. The obstruction identification model 400 determined a detection ground plane 605A of the image data, which the obstruction identification model 400 uses to identify obstructions 615A in the image data. In FIG. 6A, the obstructions 615A identified by the obstruction identification model 400 are the cars 610A in the background.

In FIG. 6B, the image rendering 600C of image data of a person 620 and a box 625 in a parking lot. The image rendering 600D shows a detection ground plane 605B of the image data determined by the obstruction identification model 400. The detection ground plane 605B covers the ground pf the parking lot but does not include the person 620 or the box 625. Image rendering 600E depicts obstructions 615B of the image data, which are the person 620 and the box 625. The obstruction identification model 400 sends these obstructions 615B to the action generation module 410, and the action generation module 410 controls the farming machine 100 to avoid the obstructions 615B.

### V. Computer System

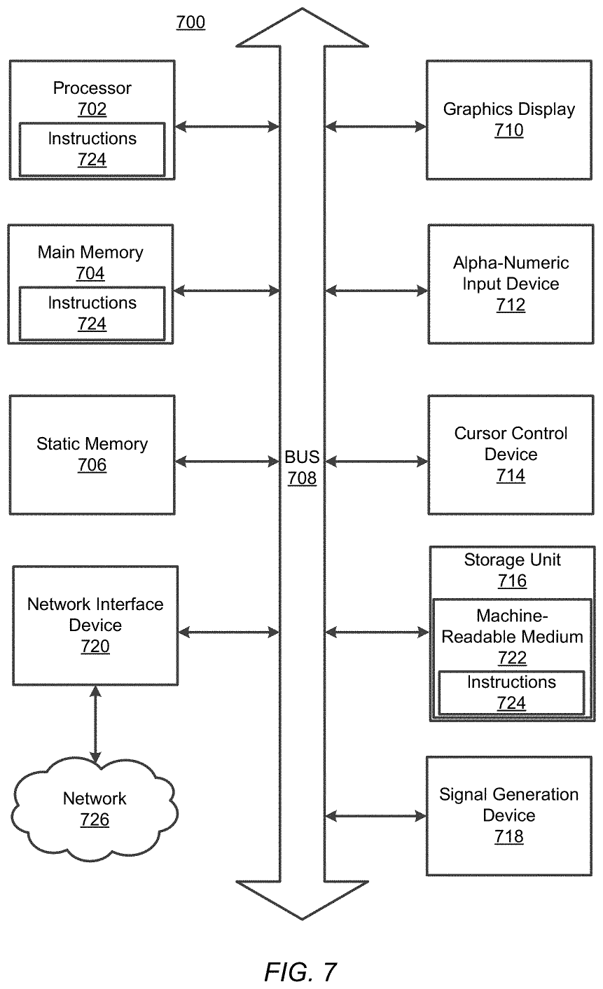

FIG. 7 is a block diagram illustrating components of an example machine for reading and executing instructions from a machine-readable medium. Specifically, FIG. 7 shows a diagrammatic representation of control system 130 in the example form of a computer system 700. The computer system 700 can be used to execute instructions 724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processing units (generally processor 702). The processor 702 is, for example, a central processing unit (CPU), a graphics processing unit (GPU), a digital signal processor (DSP), a control system, a state machine, one or more application specific integrated circuits (ASICs), one or more radio-frequency integrated circuits (RFICs), or any combination of these. The computer system 700 also includes a main memory 704. The computer system may include a storage unit 716. The processor 702, memory 704, and the storage unit 716 communicate via a bus 708.

In addition, the computer system 700 can include a static memory 706, a graphics display 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. For example, the instructions 724 may include the functionalities of modules of the system 130 described in FIG. 2. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 may be transmitted or received over a network 726 via the network interface device 720.

### IX. Additional Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine 100. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for identifying and treating plants with a farming machine including a control system executing a semantic segmentation model. Thus, while particular embodiments and applications have been illustrated and described, it is to be understood that the disclosed embodiments are not limited to the precise construction and components disclosed herein. Various modifications, changes and variations, which will be apparent to those, skilled in the art, may be made in the arrangement, operation and details of the method and apparatus disclosed herein without departing from the spirit and scope defined in the appended claims.

What is claimed is:

1. A method for detecting an obstruction as a farming machine traverses a field, the method comprising:
receiving, from an image acquisition system, image data of a field portion comprising a plurality of pixels, wherein each pixel in the plurality of pixels represents a three dimensional coordinate in the field;
applying an obstruction identification model to identify the obstruction in the field, wherein the obstruction identification model:
determines a seed segment for the field portion, the seed segment comprising a set of pixels with characteristics extrapolatable to the field portion;
determines a detection ground plane for the field portion by extrapolating characteristics of the seed segment to the three dimensional coordinates of the plurality of pixels, and
identifies the obstruction as a set of pixels of the plurality of pixels having three dimensional coordinates above the detection ground plane; and
executing an action such that the farming machine avoids the identified obstruction in the field.

2. The method of claim 1, wherein extrapolating the seed segment comprises:
extrapolating the characteristics of the seed segment to the field portion using a two dimensional representation of the three dimensional coordinates for the plurality of pixels.

3. The method of claim 1, wherein determining the seed segment comprises:
determining the seed segment from the image data as the farming machine moves through the field, wherein the set of pixels of the seed segment comprises received image data representing a plane.

4. The method of claim 1, wherein determining the seed segment comprises:
accessing the seed segment from a datastore, the accessed seed segment extrapolated from previously captured image data of one or more other fields and comprising a previously captured set of pixels comprising image data representing a plane.

5. The method of claim 1, wherein identifying the obstruction comprises:
removing pixels of the detection ground plane from the image data of the field portion;
segmenting the remaining image data into one or more buckets based on distance to the farming machine;
binning pixels of the remaining image data having three dimensional coordinates above the detection ground plane into the buckets; and
identifying buckets comprising binned pixels as obstructions.

6. The method of claim 5, wherein binning pixels into in the buckets comprises binning the pixels as one dimensional tubes.

7. The method of claim 5, wherein binning pixels comprises:
applying k-means clustering to the pixels in the remaining image data; and
adding clusters to the buckets.

8. The method of claim 5, wherein binning pixels comprises:
inputting binned pixels into a machine learning model, wherein the machine learning model classifies the binned pixels as static obstructions or dynamic obstructions and is trained on labelled image data of static and dynamic obstructions; and
labeling the binned pixels based on output from the machine learning model.

9. The method of claim 5, wherein binning pixels comprises:
receiving two or more sets of image data at periodic time intervals as the farming machine traverses the field;
binning pixels in each set of image data;
comparing locations of the binned pixels in each set of image data to determine if obstructions corresponding to the binned pixels are static or dynamic; and
labelling the binned pixels based on the comparison.

10. The method of claim 1, wherein the action comprises one or more of causing the farming machine to stop, slow down, or sound an alarm.

11. The method of claim 1, wherein executing the action such that the farming machine avoids the obstruction in the field comprises:
retrieving a path of the farming machine in the field;
replanning the path to avoid the obstruction in the field; and
instructing the farming machine to follow the replanned path.

12. A non-transitory computer-readable storage medium storing instructions that when executed cause a processor to perform a method comprising:
receiving, from an image acquisition system, image data of a field portion comprising a plurality of pixels, wherein each pixel in the plurality of pixels represents a three dimensional coordinate in the field;
applying an obstruction identification model to identify the obstruction in the field, wherein the obstruction identification model:
determines a seed segment for the field portion, the seed segment comprising a set of pixels with characteristics extrapolatable to the field portion;
determines a detection ground plane for the field portion by extrapolating characteristics of the seed segment to the three dimensional coordinates of the plurality of pixels, and
identifies the obstruction as a set of pixels of the plurality of pixels having three dimensional coordinates above the detection ground plane; and
executing an action such that the farming machine avoids the identified obstruction in the field.

13. The non-transitory computer-readable storage medium of claim 12, wherein extrapolating the seed segment comprises:
extrapolating the characteristics of the seed segment to the field portion using a two dimensional representation of the three dimensional coordinates for the plurality of pixels.

14. The non-transitory computer-readable storage medium of claim 12, wherein determining the seed segment further comprises instructions that further cause the processor to perform a method comprising:
determining the seed segment from the image data as the farming machine moves through the field, wherein the set of pixels of the seed segment comprises received image data representing a plane.

15. The non-transitory computer-readable storage medium of claim 12, wherein determining the seed segment further comprises instructions that further cause the processor to perform a method comprising:
accessing the seed segment from a datastore, the accessed seed segment extrapolated from previously captured image data of one or more other fields and comprising a previously captured set of pixels comprising image data representing a plane.

16. The non-transitory computer-readable storage medium of claim 12, wherein identifying the obstruction further comprises instructions that further cause the processor to perform a method comprising:
removing pixels of the detection ground plane from the image data of the field portion;
segmenting the remaining image data into one or more buckets based on distance to the farming machine;
binning pixels of the remaining image data having three dimensional coordinates above the detection ground plane into the buckets; and
identifying buckets comprising binned pixels as obstructions.

17. The non-transitory computer-readable storage medium of claim 16, wherein binning pixels into in the buckets comprises binning the pixels as one dimensional tubes.

18. The non-transitory computer-readable storage medium of claim 16, wherein binning pixels further comprises instructions that further cause the processor to perform a method comprising:
applying k-means clustering to the pixels in the remaining image data; and
adding clusters to the buckets.

19. The non-transitory computer-readable storage medium of claim 16, wherein binning pixels further comprises instructions that further cause the processor to perform a method comprising:
inputting binned pixels into a machine learning model, wherein the machine learning model classifies the binned pixels as static obstructions or dynamic obstructions and is trained on labelled image data of static and dynamic obstructions; and
labeling the binned pixels based on output from the machine learning model.

20. A computer system comprising:
a processor; and
a non-transitory computer-readable storage medium storing instructions that when executed cause the processor to perform actions comprising:
receiving, from an image acquisition system, image data of a field portion comprising a plurality of pixels, wherein each pixel in the plurality of pixels represents a three dimensional coordinate in the field;
applying an obstruction identification model to identify the obstruction in the field, wherein the obstruction identification model:
determines a seed segment for the field portion, the seed segment comprising a set of pixels with characteristics extrapolatable to the field portion;
determines a detection ground plane for the field portion by extrapolating characteristics of the seed segment to the three dimensional coordinates of the plurality of pixels, and
identifies the obstruction as a set of pixels of the plurality of pixels having three dimensional coordinates above the detection ground plane; and
executing an action such that the farming machine avoids the identified obstruction in the field.
